(19) United States
(12) Patent Application Publication
(10) Pub. No.: US 2009/0284785 A1
(43) Pub. Date: Nov. 19, 2009

(54) IMAGE FORMATION DEVICE AND IMAGE FORMATION SYSTEM

(75) Inventor: Ryoji Bando, Sakai-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/421,932

(22) Filed: Apr. 10, 2009

(30) Foreign Application Priority Data
May 13, 2008 (JP) 2008-125401

(51) Int. Cl. G06F 3/12

(52) U.S. Cl. 358/1.15

(57) ABSTRACT

An image formation device stores therein print data targeted for secure printing received through a network. When a user is authenticated by a user authentication part, the image formation device reads the print data targeted for secure printing to execute a print job. The image formation device includes a job management part for managing the stored print data targeted for secure printing. When a print job is not executed at a point in time after the elapse of a predetermined period of time after the receipt of the print data targeted for secure printing, the job management part encrypts the print data using a certain encryption key, and transmits the encrypted print data to an intended device connected to the network. Namely, when a printout of the print data targeted for secure printing received through the network is not obtained at a point in time after the elapse of a predetermined period of time, the print data is transmitted to another device connected to the network with the security of the print data maintained. As a result, a printout of the print data is obtained by another image formation device.

This application is based on the application No. 2008-125401 filed in Japan, the contents of which are hereby incorporated by reference.

### BACKGROUND OF THE INVENTION

1. Field of the Invention

The present invention relates to an image formation device connected to a network and an image formation system, and more particularly, relates to a technique of performing printing based on print data targeted for secure printing received through the network.

2. Description of the Background Art

In recent years, an image formation device such as a printer, a complex device or an MFP (multifunction peripheral) is connected to a network to construct an image formation system. In this image formation system, the image formation device receives print data through the network from a personal computer (PC), and the like, to execute a print job. In this image formation system, the image formation device is shared among several users. Hence, for the printing of confidential information, etc., a printed matter should not be exposed to outsiders. Thus, a conventionally used image formation device has a confidential print function that is what is called “secure printing”. When print data targeted for secure printing is received, a print job based on this print data is not executed immediately. Instead, the received print data is once stored in an internal storage part. When a user directly operates the image formation device to give instructions in order to generate a printout, the print data stored in the storage part is read to execute a print job.

Even when a user transmits print data targeted for secure printing from a PC and the like to the image formation device, the user may forget to perform operation for generating a printout after the elapse of time after transmission. In this case, the storage part of the image formation device is occupied by the forgotten print data, and confidential information is kept inside the image formation device. In response, the conventionally used image formation device is so configured that, when a print job based on print data targeted for secure printing stored in the storage part is not executed at a point in time after the elapse of a predetermined period of time, the user is informed of this fact so that the generation of a printout is not forgotten, or the print data is automatically deleted from the storage part (see for example Japanese Patent Application Laid-Open No. 2006-321144 or 2006-127429).

A user has conventionally had a problem that, even when the user after being informed of the fact from the image formation device that a print job has not been executed wants to generate a printout immediately, the user if at a place away from the image formation device cannot obtain a printout in situ. By way of example, in order to print a document necessary for a meeting or a business trip, the user has transmitted data of this document as print data targeted for secure printing to the image formation device. However, if the image formation device is used exclusively by another user or used exclusively for another job, or if the image formation device is in an error condition at the time of transmission, the user cannot generate a printout immediately, and may leave the document unprinted. When the user is informed of the fact from the image formation device that a print job has not been executed during the meeting or business trip, the user cannot obtain a printout of the print data in situ even when the user would like to get the printout.

### SUMMARY OF THE INVENTION

First, the present invention is intended for an image formation device.

According to one aspect of the present invention, the image formation device is connected to a network, and comprises: a storage part for storing therein print data targeted for secure printing received through the network; an authentication part responsible for user authentication; a job execution part for reading the print data targeted for secure printing from the storage part to execute a print job when a user is authenticated by the authentication part; and a job management part for managing the print data targeted for secure printing stored in the storage part. When a print job is not executed at a point in time after the elapse of a predetermined period of time after the receipt of the print data targeted for secure printing, the job management part encrypts the print data using a certain encryption key, and transmits the encrypted print data to an intended storage device connected to the network.

According to this aspect, after the elapse of a predetermined period of time after the receipt of the print data targeted for secure printing, the image formation device encrypts the print data, and transmits the encrypted print data to the intended storage device connected to the network. Thus, the print data is transmitted to another device connected to the network with the security of the print data maintained. After transmission of the print data, by operating another image formation device connected to the network, for example, the print data is retrieved from the device to which the print data has been transmitted to obtain a printout.

Second, the present invention is intended for an image formation system.

According to one aspect of the present invention, the image formation system comprises: a first image formation device connected to a network; a first image formation device connected to the network; a server connected to the network, and including a storage device for storing therein print data transmitted from the first or second image formation device; and an information processing device connected to the network, and transmitting print data targeted for secure printing to the first or second image formation device. The first and second image formation devices each include: a manipulated input part for receiving manipulation from a user, a storage part for storing therein the print data targeted for secure printing received from the information processing device; an authentication part responsible for user authentication; a job execution part for reading the print data targeted for secure printing from the storage part to execute a print job when a user is authenticated by the authentication part; and a job management part for managing the print data targeted for secure printing stored in the storage part. When a print job is not executed at a point in time after the elapse of a predetermined period of time after the receipt of the print data targeted for secure printing, the job management part encrypts the print data using a certain encryption key, and transmits the encrypted print data to the server to store the encrypted print data into the storage device, while transmitting information for making access to a destination to save the encrypted print data through the network to a source of the print data targeted for secure printing. In the first or second image formation device, when instructions to obtain a printout of print data transmitted to the server are received through the manipulated input part, the job management part of the image formation device makes access to the storage device of the server based on the information entered through the manipulated input part to retrieve the encrypted print data, decrypts the encrypted print data using a certain decryption key, and causes the job execution part of the image formation device to execute a print job.

According to this aspect, when a print job is not executed at a point in time after the elapse of a predetermined period of time after the receipt of the print data targeted for secure printing in the first or second image formation device, the print data is transmitted to the server connected to the network to be stored in the storage device therein with the security of the print data maintained. Further, information for making access to a destination to save the print data transmitted from this image formation device is notified. Thus, by operating either the first or second image formation device, the print data is retrieved from the server and a print job is executed to thereby obtain a printout.

It is therefore an object of the present invention to provide an image formation device and an image formation system in which, when a print job based on print data targeted for secure printing received through a network is not executed at a point in time after the elapse of a predetermined period of time, the print data targeted for secure printing is transmitted to another device connected to the network with the security of the print data maintained and a user operates another image formation device connected to the network, thereby obtaining a printout.

### BRIEF DESCRIPTION OF THE DRAWINGS

FIG. 1 schematically shows the configuration of an image formation system of a first preferred embodiment of the present invention;

FIG. 2 is a block diagram showing the functional configuration of the image formation system of the first preferred embodiment;

FIG. 3 shows an example of user information stored in advance in a storage part;

FIG. 4 shows an example of print job data;

FIG. 5 is a flow diagram showing a process sequence performed by an information processing device to transmit print data to an image formation device;

FIG. 6 is a flow diagram showing a process sequence performed by the image formation device when a print job targeted for secure printing is received from the information processing device;

FIG. 7 is a flow diagram showing a process sequence performed repeatedly at a constant frequency by a job management part of the image formation device;

FIG. 8 is a flow diagram showing a process sequence performed by a server when encrypted print data is received by the server;

FIG. 9 is a flow diagram showing a process sequence performed by the image formation device to execute a print job;

FIG. 10 is a flow diagram showing a process sequence repeatedly performed at a constant frequency by the job management part of the image formation device in a second preferred embodiment of the present invention;

FIG. 11 is a flow diagram showing a process sequence performed by the image formation device to execute a print job in the second preferred embodiment;

FIG. 12 is a block diagram showing the functional configuration of an image formation system of a third preferred embodiment of the present invention;

FIG. 13 is a flow diagram showing a process sequence repeatedly performed at a constant frequency by the job management part of the image formation device in the third preferred embodiment;

FIG. 14 is a flow diagram showing a process sequence performed by the image formation device when the information processing device makes access to a Web server part;

FIG. 15 is a flow diagram showing a process sequence repeatedly performed at a constant frequency by the job management part of the image formation device in a fourth preferred embodiment of the present invention; and

FIGS. 16 and 17 are flow diagrams showing a process sequence performed by the image formation device when the information processing device makes access to the Web server part.

### DESCRIPTION OF THE PREFERRED EMBODIMENTS

Preferred embodiments of the present invention are described in detail below with reference to figures. In the description given below, those elements which are shared in common among the preferred embodiments are represented by the same reference numerals, and these elements are not discussed repeatedly for the same description.

### First Preferred Embodiment

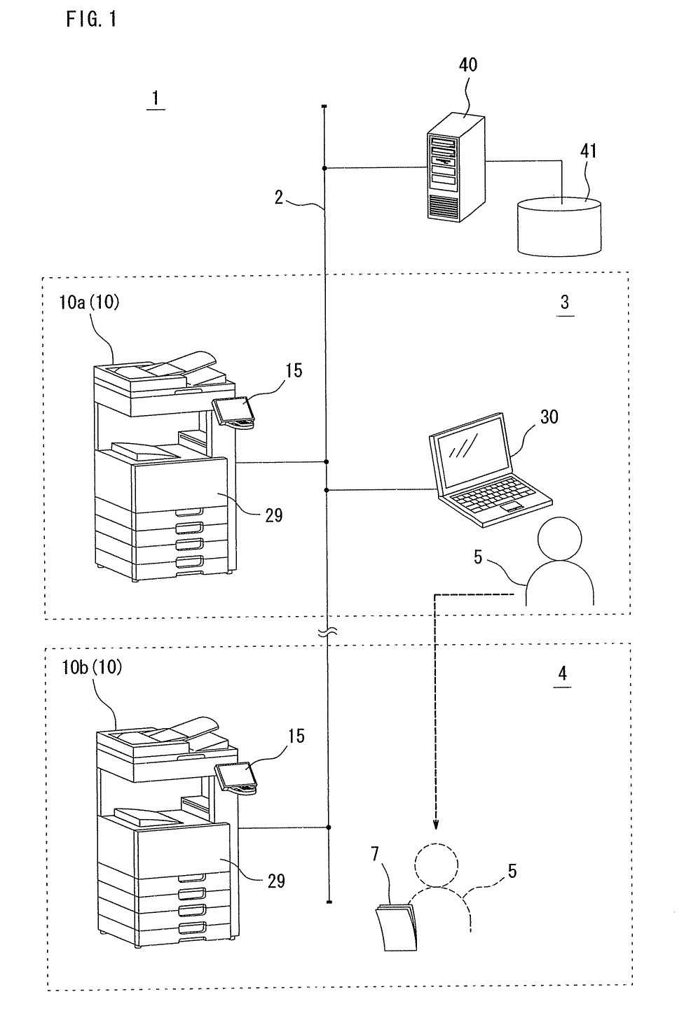

FIG. 1 schematically shows the configuration of an image formation system 1 of a first preferred embodiment of the present invention. The image formation system 1 comprises a network 2 constituted by a wired LAN, a wireless LAN, an intranet or the like, and a plurality of image formation devices 10 (10a, 10b), an information processing device 30 and a server 40 connected to the network 2. In FIG. 1, two image formation devices including 10a and 10b are shown to be connected to the network 2. The image formation devices 10a and 10b are collectively designated as image formation device 10 when distinction therebetween is not necessary. The number of image formation devices 10 connected to the network 2 is not limited to two. Three or more image formation devices 10 may be connected to the network 2. Other apparatuses or devices may be connected to the network 2.

The plurality of image formation devices 10 may be installed in an arbitrary place. In the first preferred embodiment, the image formation device 10a is installed in an office 3 in which a user 5 usually works, and the image formation device 10b is installed in an office 4 separate from the office 3. The image formation device 10 is what is called a complex machine or an MFP, and has several functions as a copier, a FAX, a printer, a scanner, and others. The image formation device 10 is provided with an operation panel 15 on its front, which functions as a manipulated input part for receiving manipulation from a user, and a printer mechanism 29 inside for forming an image on an image formation medium such as a sheet to generate a printout. The printer mechanism 29 executes a print job based on print data received for example from the information processing device 30 through the network 2.

The information processing device 30 is formed from a generally-used personal computer (PC) and the like. The user 5 mainly uses the information processing device 30, normally in a condition where the information processing device 30 is connected to the network 2 in the office 3. A user operates the information processing device 30, so that the information processing device 30 transmits print data to the image formation device 10. At this time, when the user selects secure printing in order to print confidential information, etc., the information processing device 30 generates print data targeted for secure printing, and transmits the same to the image formation device 10. If the information processing device 30 is formed, for example, from a portable notebook PC, the user 5 can carry the information processing device 30 as the user 5 moves. Hence, the user 5 is allowed to carry the information processing device 30 into the office 4, and use the information processing device 30 there after connecting the information processing device 30 to the network 2.

The server 40 is formed from a generally-used computer, and includes therein a storage device 41 such as a hard disk. The server 40 may be installed in an arbitrary place. As an example, the server 40 may be installed in the office 3, or in the office 4. Alternatively, as shown in FIG. 1, the server 40 may be installed in a place other than the offices 3 and 4. What is important is that the image formation device 10a installed in the office 3 and the image formation device 10b installed in the office 4 are both accessible to the server 40 through the network 2. The server 40 functions as what is called a pull print server, and stores print data received through the network 2 into the storage device 41. When a user operates the operation panel 15 of the image formation device 10 to give instructions for the printing of print data stored in the server 40, the image formation device 10 makes access to the server 40 through the network 2, retrieves the designated print data from the storage device 41 of the server 40, and executes a print job based on the retrieved print data.

In the image formation system 1 of the first preferred embodiment, when the user 5 operates the information processing device 30 for example in the office 3 to transmit print data targeted for secure printing to the image formation device 10a, the image formation device 10a temporarily stores the print data targeted for secure printing inside. When the user 5 operates the operation panel 15 of the image formation device 10a to give instructions for printing within a predetermined period of time, the image formation device 10a reads the print data targeted for secure printing stored therein to execute a print job. When the user 5 does not give instructions for printing within a predetermined period of time, the image formation device 10a transfers the print data targeted for secure printing stored therein to the server 40 through the network 2. So, the server 40 stores the print data targeted for secure printing received from the image formation device 10a into the storage device 41. Along with the transfer of the print data targeted for secure printing to the server 40, the image formation device 10a notifies the user 5 of information for making access to the print data thereby transferred. At this time, when the user 5 has moved from the office 3 to the office 4 as indicated by a dashed line in FIG. 1, the user 5 may receive a notice from the image formation device 10a in the office 4. Then, the user 5 operates the operation panel 15 of the nearest image formation device 10b based on information contained in the notice from the image formation device 10a, so that the image formation device 10b retrieves the print data targeted for secure printing from the server 40 to execute a print job. Thus, in the image formation system 1 of the first preferred embodiment, even when the user 5 is away from the image formation device 10a from which print data targeted for secure printing has been transmitted first, the user 5 is allowed to obtain a printout 7 based on the print data targeted for secure printing by operating the nearest image formation device 10b. The image formation system 1 is described in more detail below.

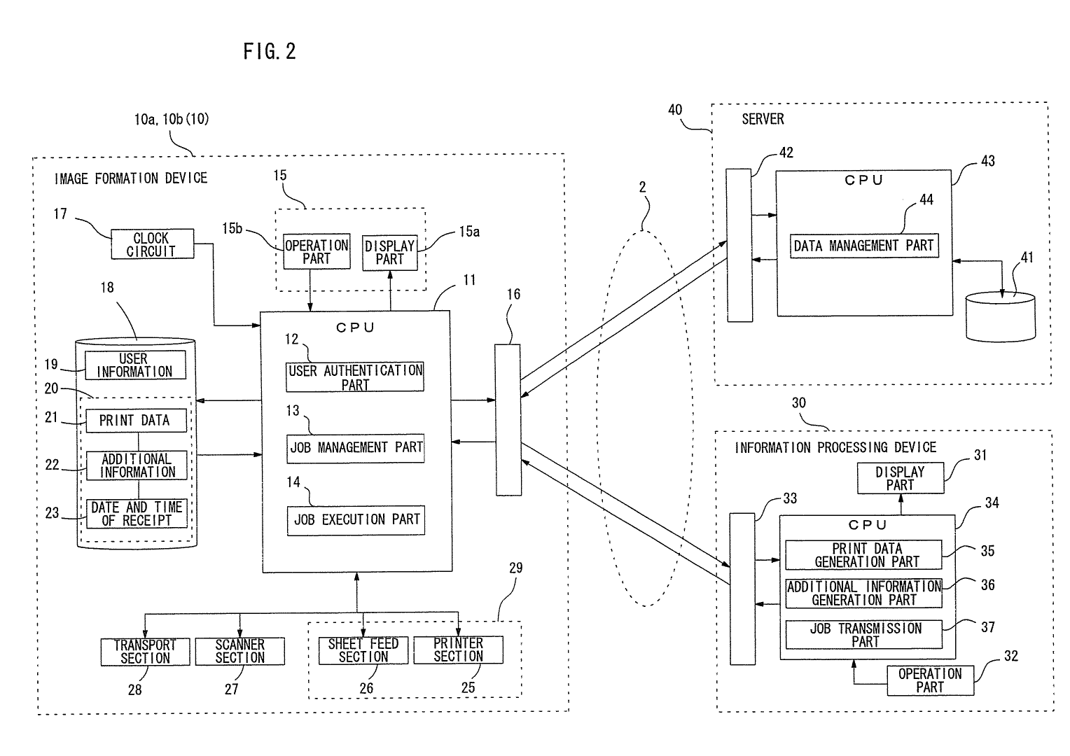

FIG. 2 is a block diagram showing the functional configuration of the image formation system 1 of the first preferred embodiment. In the first preferred embodiment, the image formation devices 10a and 10b have the same configuration. The image formation device 10 includes a CPU 11 that executes a certain program to control each element inside the image formation device 10, the above-discussed operation panel 15, a communication interface 16 for making connection with the network 2, a clock circuit 17 for outputting current time, a storage part 18 formed from a hard disk and the like, a printer section 25, a sheet feed section 26, a scanner section 27, and an original transport section 28.

The operation panel 15 is formed from a liquid crystal display and the like. The operation panel 15 has a display part 15a for presenting various types of information to a user, and an operation part 15b formed from a touch panel, a plurality of operation buttons arranged around the display part 15a, etc., and which receives the manipulation from the user. The storage part 18 stores therein information on users as user information 19 who are registered with the image formation device 10. The storage part 18 also stores therein print job data 20 targeted for secure printing the image formation device 10 has received from the information processing device 30 through the network 2. The printer section 25 and the sheet feed section 26 constitute the above-discussed printer mechanism 29. When the image formation device 10 generates a printout, the sheet feed section 26 feeds sheets one by one to the printer section 25, and the printer section 25 forms images upon these sheets. The scanner section 27 and the original transport section 28 constitute an image reading part. As an example, the original feed section 28 transports originals one by one to the scanner section 27, and the scanner section 27 read images from these originals. In the first preferred embodiment, the image formation device 10 is illustratively a complex device or an MFP, so the image formation device 10 has the scanner section 27 and the original transport section 28. When the image formation device 10 is dedicated to printing, for example, the scanner section 27 and the original transport section 28 are not provided.

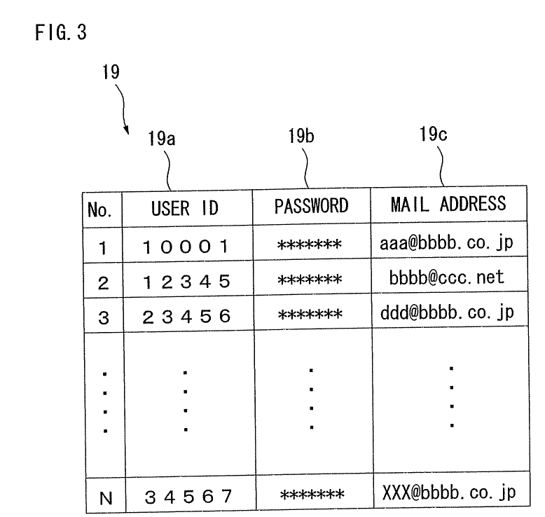

In order to process print data targeted for secure printing, the CPU 10 is operative to function as a user authentication part 12, a job management part 13 and a job execution part 14. The user authentication part 12 performs user authentication when a print job targeted for secure printing is executed. The user authentication part 12 makes reference to the user information 19 stored in advance in the storage part 18. FIG. 3 shows an example of the user information 19. The user information 19 contains a user ID 19a for specifying a user, a password 19b that can be freely set by a user, and an electronic mail address 19c for providing various types of information to a user. When a print job targeted for secure printing is executed, the user authentication part 12 specifies a user based on the user ID 19a, recognizes the user as a proper user when an input given thereto coincides with the password 19b set for the user, and permits the execution of the print job targeted for secure printing.

The job management part 13 stores print data targeted for secure printing received from the information processing device 30 into the storage part 18, and is responsible for the management of print data targeted for secure printing. When print data the image formation device 10 has received from the information processing device 30 through the network 2 is targeted for secure printing, additional information is received together with the print data. When the job management part 13 receives print data targeted for secure printing from the information processing device 30, the job management part 13 obtains the time of receipt from the clock circuit 17, and stores the received print data as print job data 20 in which print data 21 targeted for secure printing, additional information 22 added to the print data 21, and date and time of receipt 23 are linked into the storage part 18.

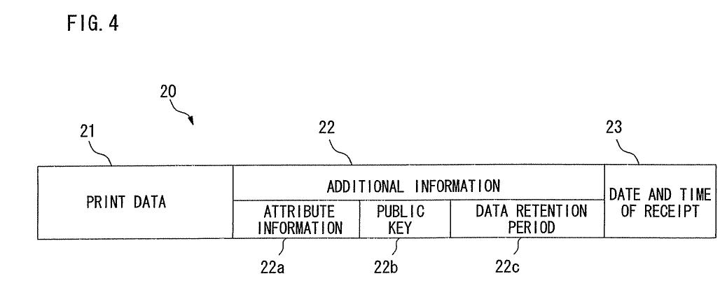

FIG. 4 shows an example of the print job data 20. The print job data 20 contains the print data 21 in such a format that allows the image formation device 10a or 10b to execute a print job of the print data 21 as it is, the additional information 22, and the date and time of receipt 23. The additional information 22 contains attribute information 22a, a public key 22b, and a data retention period 22c. The attribute information 22a contains information indicating that the print data 21 is targeted for secure printing, and information for specifying a user (such as a user ID, for example). The public key 22b is used by the job management part 13 to encrypt the print data 21 to transfer this print data 21 to the server 40 after a data retention period has elapsed after the receipt of the print data 21. The public key 22b is provided with a secret key as a counterpart thereof for decryption. Information encrypted by the public key 22b cannot be decrypted properly unless decrypted by the secret key as a counterpart of the public key 22b. The data retention period 22c defines a period during which print data targeted for secure printing is to be held in the image formation device 10. The data retention period 22c may be arbitrarily set, for example in a range of several minutes to several hours or several days.

The job management part 13 manages the print data 21 targeted for secure printing that is being stored in the storage part 18 until a predetermined period of time recorded as the data retention period 22c has elapsed from the date and time of receipt 23. After the predetermined period of time recorded as the data retention period 22c has elapsed after the date and time of receipt 23, the job management part 13 reads the print data 21 targeted for secure printing from the storage part 18, encrypts the print data 21 using the public key 22b contained in the additional information 22, and transfers the print data thereby encrypted to the server 40. Along with this transfer, the job management part 13 reads the electronic mail address 19c of a user from the user information 19, and sends an electronic mail to the user from which the print data 21 targeted for secure printing has been sent, thereby transmitting information on the transfer destination of the print data 21 to the user.

The job execution part 14 controls the printer section 25, the sheet feed section 26, the scanner section 27 and the original transport section 28, thereby controlling the execution of a job designated by the image formation device 10. Especially when a print job is targeted for secure printing, and as long as a user is successfully authenticated by the user authentication part 12, the job execution part 14 reads the print data 21 targeted for secure printing from the storage part 18, and controls the printer mechanism 29 including the printer section 25 and the sheet feed section 26 to execute the print job.

The information processing device 30 includes a display part 31 such as a liquid crystal display, an operation part 32 such as a keyboard, a communication interface 33 for making connection with the network 2, and a CPU 34. The CPU 34 executes a certain program such as a printer driver for outputting print data to the image formation device 10 to thereby function as a print data generation part 35, an additional information generation part 36 and a job transmission part 37. The print data generation part 35 generates the print data 21 from the data of a document such as a confidential document, for example, in a format that is applicable as a print job by the image formation device 10. The additional information generation part 36 generates the additional information 22 discussed above. When a user operates the operation part 32 to select secure printing, information indicating that the print data 21 is targeted for secure printing and information for specifying a user are added to the attribute information 22a. Further, a public key entered by the user is set as the public key 22b of the additional information 22, and a data retention period entered by the user is set as the data retention period 22c of the additional information 22. The job transmission part 37 transmits the print data 21 generated by the print data generation part 35 and the additional information 22 generated by the additional information generation part 36 to the image formation device 10 designated by the user.

The server 40 includes, in addition to the storage device 41 discussed above, a communication interface 42 for making connection with the network 2, and a CPU 43. The CPU 43 executes a certain program for causing the server 40 to function as a pull print server to thereby function as a data management part 44. The data management part 44 stores the print data 21 targeted for secure printing received from the image formation device 10 through the network 2 into the storage device 41. The data management part 44 also puts restrictions on access to the print data 21 stored in the storage device 41. By way of example, the data management part 44 sets a password for protecting a folder containing the print data 21. When a request to access the print data 21 targeted for secure printing stored in the storage device 41 is made through the network 2, the data management part 44 rejects the request unless an input made thereto coincides with the password. When an input made to the data management part 44 coincides with the password, the data management part 44 accepts the request to allow the image formation device 10 connected to the network 2 to retrieve the print data 21 targeted for secure printing from the storage device 41. The password set by the data management part 4 may be a one-time password (temporary password allowing access to a folder containing the print data 21 only once), for example. In this case, even a user without the right to access the server 40 is allowed to temporarily access the server 40 by using the one-time password, so that the user can retrieve the print data 21 targeted for secure printing from the storage device 41 of the server 40.

The operation of the image formation system 1 with the above-mentioned configuration is discussed next. In the case given by way of example in the following, the user 5 operates the information processing device 30 to transmit print data targeted for secure printing to the image formation device 10a. After the elapse of a predetermined period of time, the user 5 operates the image formation device 10b to cause the image formation device 10b to execute a print job.

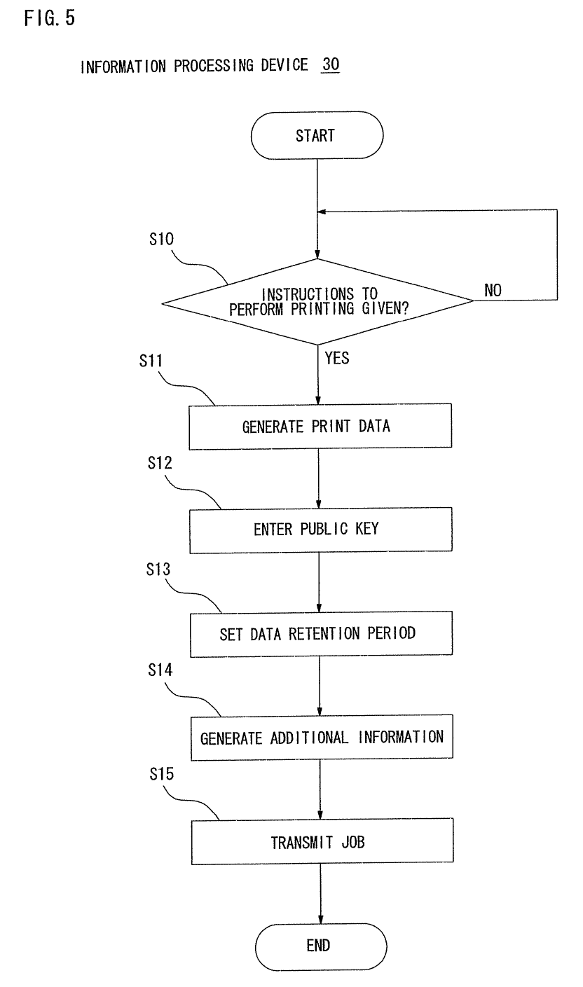

FIG. 5 is a flow diagram showing a process sequence performed by the information processing device 30 to transmit print data to the image formation device 10a. The user 5 operates the information processing device 30, reads a confidential document and the like, and gives instructions to print the confidential document by secure printing. When the user 5 gives instructions to perform secure printing (if a result of step S10 is YES), the print data generation part 35 generates the print data 21 to be given to the image formation device 10a (step S11). Thereafter the additional information generation part 36 becomes operative to receive the public key 22b entered by the user 5 (step S12). The user 5 has two pieces of key information including a public key and a secret key. The user 5 operates the operation part 32 to enter only the public key. When the entry of the public key 22b is completed, the user 5 sets the data retention period 22c (step S13). The data retention period 22c may be about several hours that is a default value which may be freely changed by the user 5 in step S13. The additional information generation part 36 generates the attribute information 22b containing information indicating that the print data 21 is targeted for secure printing and information for specifying a user. The additional information generation part 36 also sets the public key 22b based on the information entered in step S12 and sets the data retention period 22c based on the information entered in step S13, thereby generating the additional information 22 to be added to the print data 21 (step S14). Thereafter the job transmission part 37 becomes operative to transmit the print data 21 targeted for secure printing and the additional information 22 to the image formation device 10a through the network 2 (step S15), by which a print job is transmitted from the information processing device 30 to the image formation device 10a.

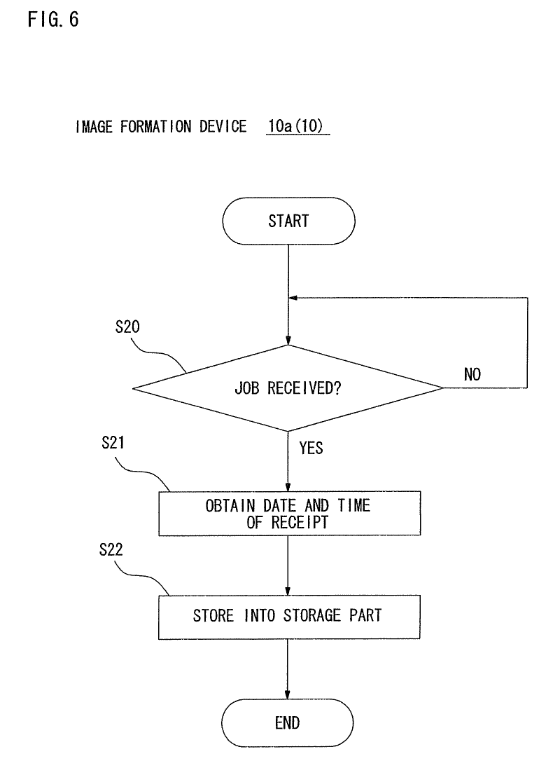

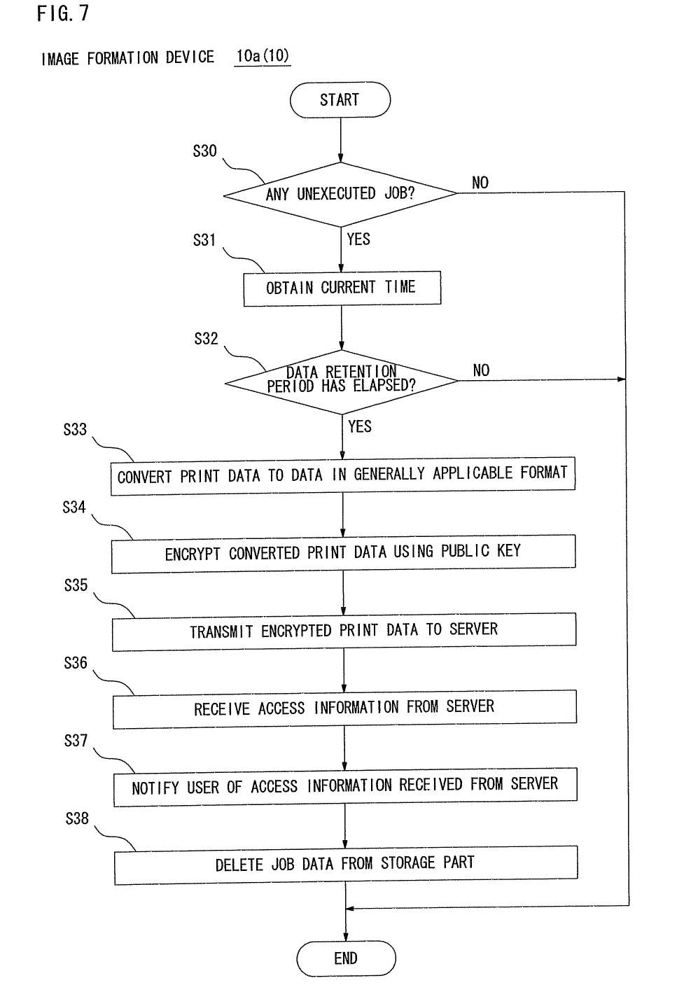

FIG. 6 is a flow diagram showing a process sequence performed by the image formation device 10a when a print job is received from the information processing device 30. In the image formation device 10a, the job management part 13 monitors the receipt of a print job through the communication interface 16 (step S20). When a print job is received (when a result of step S20 is YES), the job management part 13 obtains date and time of receipt from the clock circuit 17 (step S21). Then, the job management part 13 associates the date and time of receipt 23 with the print data 21 and the additional information 22 received from the information processing device 30, and stores the information thereby associated as the print job data 20 into the storage part 18 (step S22). The image formation device 10a thereby completes the storage of the print data 21 received from the information processing device 30. By the time a predetermined period of time set as the data retention period 22c has elapsed after the image formation device 10a had received the print data 21, the user 5 moves to a place where the image formation device 10a is installed. Then, the user 5 enters a password contained in the user information 19 by operating the operation panel 15 to be authenticated as a user. When the user 5 gives instructions to execute a print job based on the print data 21 targeted for secure printing, the print job is executed at the image formation device 10a. In the image formation device 10a, the job management part 13 manages the print data 21 stored in the storage part 18. When the user 5 does not perform the foregoing operation on the image formation device 10a by the time the predetermined period of time set as the data retention period 22 has elapsed, process steps based on the flow diagram shown in FIG. 7 are performed.

FIG. 7 is a flow diagram showing a process sequence repeatedly performed at a constant frequency by the job management part 13 of the image formation device 10a. First, the job management part 13 searches the storage part 18 to check whether or not an unexecuted print job is stored therein (step S30). When an unexecuted print job is not stored in the storage part 18 (when a result of step S30 is NO), no subsequent process is required so the process sequence stops here. When an unexecuted print job is stored in the storage part 18 (when a result of step S30 is YES), the job management part 13 obtains current time from the clock circuit 17 (step S31). Then, the job management part 13 compares the current time and the date and time of receipt 23 of the print data 21 to check whether or not a period of time set as the data retention period 22c of the additional information 22 has elapsed after the receipt of the print data 21 (step S32). When the data retention period has not elapsed (when a result of step S32 is NO), no subsequent process is required so the process sequence stops here. When the data retention period has already elapsed (when a result of step S32 is YES), subsequent process (steps S33 to S38) follows.

When the data retention period of the print data 21 has already elapsed, the job management part 13 first reads the print data 21 stored in the storage part 18, and converts the print data 21 to data in a generally applicable format (step S33). Namely, the print data 21 the image formation device 10a has received from the information processing device 30 is in a format specific to the image formation device 10a, and the image formation device 10a is allowed to execute a print job of the print data 21 as it is. So, the print data 21 is converted to data in a generally applicable format that allows another image formation device to generate a printout. By way of example, the print data 21 is converted to raster data in a generally applicable print format, or to PDF data that can be handled by an arbitrary device. The job management part 13 thereby converts the print data 21 to data in a generally applicable format, so that another image formation device is allowed to read the converted print data to execute a print job.

The job management part 13 thereafter encrypts the converted print data in the generally applicable format using the public key 22b contained in the additional information 22 (step S34). This encryption includes process realized by the job management part 13 for prohibiting the print data from being successfully decrypted unless a secret key as a counterpart of the public key 22b is used. When the encryption of the print data is completed, the job management part 13 transmits the encrypted print data to the server 40 (step S35). The attribute information 22a contained in the additional information 22 may be added to the encrypted print data transmitted to the server 40. However, the other pieces of information (public key 22b and data retention period 22c) are not added to the encrypted print data transmitted to the server 40. The job management part 13 thereby encrypts the print data 21 containing confidential information, and transmits the encrypted print data to the server 40. The public key 22b used for the encryption does not leak out to the network 2. Thus, the print data 21 is transmitted to the server 40 with the security of the print data 21 maintained.

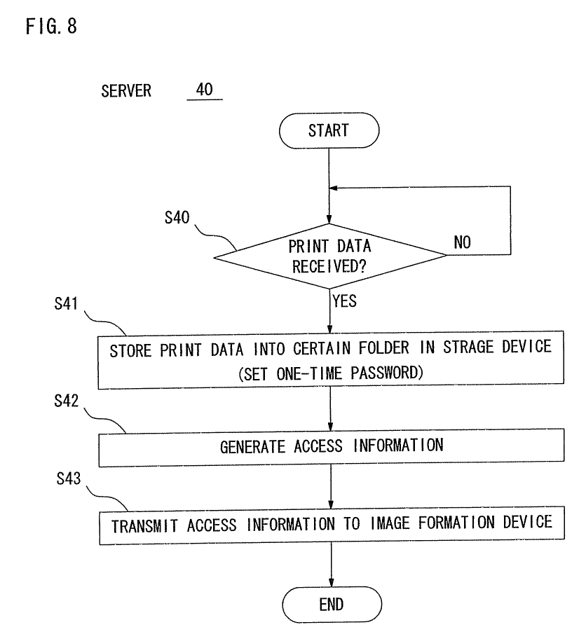

FIG. 8 is a flow diagram showing a process sequence performed by the server 40 when encrypted print data is received by the server 40. In the server 40, the data management part 44 monitors the receipt of encrypted print data through the communication interface 42 (step S40). When encrypted print data is received (when a result of step S40 is YES), the data management part 44 stores the encrypted print data into a certain folder in the storage device 41 (step S41). A new folder may be created to store therein the encrypted print data along with the receipt of the encrypted print data. In this case, a new folder may be created for each user, or for each print data. Further, restrictions are put on access to a folder for storing therein print data for example by setting a one-time password discussed above.

After storing the encrypted print data into the certain folder, the data management part 44 generates access information for making access to this folder through the network 2 (step S42). This access information contains account information and a password (such as a one-time password discussed above) for making access (login) to the server 40 through the network 2, the IP address of the server 40, information for specifying the storage device 41, information for specifying the folder in the storage device 41, the file name of the stored print data, information on a device capable of making access to the server 40 through the network 2, and others. The data management part 44 transmits the access information to the image formation device 10a from which the encrypted print data has been sent (step S43).

Turning back to FIG. 7, after transmission of the encrypted print data to the server 40 in step S35, the above-discussed process steps are performed in the server 40 so the image formation device 10a receives the access information from the server 40 (step S36). When the access information is received from the server 40, the job management part 13 notifies the user 5 of the received access information (step S37). By way of example, the job management part 13 makes reference to the user information 19 in the storage part 18, reads the electronic mail address 19c set in advance for the user 5, and transmits the access information received from the server 40 to this electronic mail address. When the electronic mail address 19c contained in the user information 19 is an electronic mail address of a mobile phone of the user 5, for example, the user 5 even if not in the office 3 is allowed to know the access information in real time as long as the user 5 carries the mobile phone. When the electronic mail address 19c contained in the user information 19 is in such a format that the information processing device 30 can view this, the user 5 is also allowed to know the access information at a place to which the user 5 has moved as long as the user 5 carries the information processing device 30.

After the notification of the access information to the user 5, the job management part 13 deletes the print job data 20 from the storage part 18 (step S38). This prevents the print job data 20 for which a print job has not been executed from continuously occupying an available area of the storage part 18 of the image formation device 10a. This also prevents confidential information from being continuously held in the storage part 18 of the image formation device 10a.

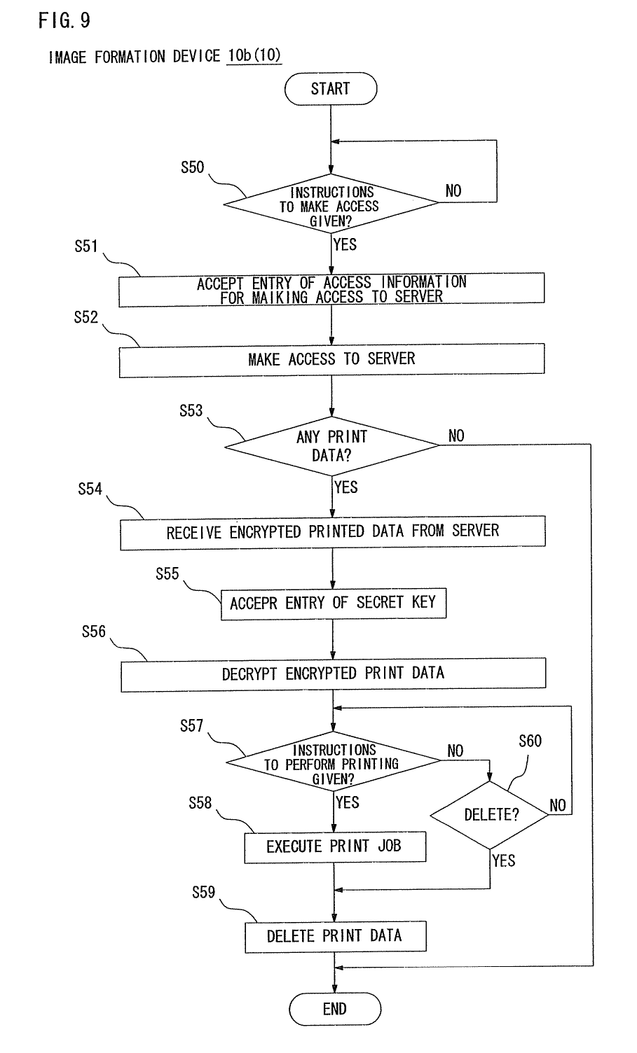

Discussed next is a procedure in which, when the user 5 is notified of access information from the image formation device 10a at a place to which the user 5 has moved, the user 5 operates the nearest image formation device 10b to cause the image formation device 10b to execute a print job targeted for secure printing, thereby obtaining the printout 7 in situ. FIG. 9 is a flow diagram showing a process sequence performed by the image formation device 10b. The user 5 operates the operation panel 15 of the image formation device 10b to give instructions to make access to the server 40 to obtain print data through the network 2 (step S50). When the user 5 gives instructions to make access to the server 40 (when a result of step S50 is YES), the job management part 13 of the image formation device 10b is brought into operation to display an entry screen for access information on the display part 15a of the operation panel 15, while accepting the entry of access information for making access to the server 40 made through the operation part 15b (step S51). At this time, the user 5 enters access information for making access to the server 40 based on the access information notified from the image formation device 10a. Then, the job management part 13 makes access to the server 40 based on the access information thereby entered (step S52). When the job management part 13 logs in to the server 40 using a one-time password entered by the user 5, for example, the server 40 is allowed to specify a folder storing therein encrypted print data corresponding to this one-time password, by which the folder becomes accessible by the job management part 13.

Thereafter the job management part 13 determines whether or not encrypted print data is stored in the folder to which access has been made (step S53). When encrypted print data is not stored in the folder (when a result of step S53 is NO), no subsequent process is practicable so the process sequence stops here. When encrypted print data is stored in the folder (when a result of step S53 is YES), the job management part 13 retrieves the encrypted print data from the server 40 (step S54). If the folder to which access has been made contains several pieces of encrypted print data, only the print data with a file name coinciding with a file name designated by the user 5 is retrieved.

The job management part 13 displays an entry screen for a secret key for decrypting the encrypted print data on the display part 15a of the operation panel 15 to accept the entry of the secret key through the operation part 15b (step S55). The user 5 enters a secret key as a counterpart of the public key 22b to the image formation device 10b. Then, the job management part 13 decrypts the encrypted print data retrieved from the server 40 using the secret key entered by the user 5 (step S56). As a result, the print data targeted for secure printing is converted to print data in a generally applicable print format such as raster data or PDF data.

When instructions for printing given from the user 5 are received through the operation panel 15 (when a result of step S57 is YES), the job management part 13 brings the job execution part 14 into operation so that the job execution part 14 executes a print job (step S58). The job execution part 14 actuates the printer mechanism 29 to form an image on a sheet based on the decrypted print data to obtain the printout 7.

When the print job is completed, the job management part 13 deletes the print data stored in the image formation device 10b, and deletes the encrypted print data stored in the server 40 (step S59). As a result, confidential information is deleted from the image formation device 10b and the server 40. In the first preferred embodiment, when instructions for printing are not given in step S57 (when a result of step S57 is NO), an inquiry as to the deletion is made to the user 5. When instructions for deletion are given (when a result of step S60 is YES), the job management part 13 deletes the print data stored in the image formation device 10b, and deletes the encrypted print data stored in the server 40 (step S59). Thus, confidential information is deleted from the image formation device 10b and the server 40 without executing a print job.

In the first preferred embodiment, when a print job based on the print data 21 targeted for secure printing the image formation device 10a has received from the information processing device 30 through the network 2 is not executed at a point in time after the elapse of a predetermined period of time, the image formation device 10a encrypts the print data 21 targeted for secure printing using the public key 22b, and transmits the encrypted print data 21 to the server 40 with the security of confidential information maintained. The transmission of the print data 21 causes the image formation device 10a to notify the user 5 of information for making access to the print data stored in the server 40. Thus, the user 5 even if at a place away from the image formation device 10a is allowed to retrieve the encrypted print data from the server 40 by operating the image formation device 10b also connected to the network 2. The user 5 enters a secret key known only to the user 5 to decrypt the encrypted print data at the image formation device 10b, by which the image formation device 10b executes a print job.

Especially in the first preferred embodiment, when encrypted print data is transmitted from the image formation device 10a to the server 40, or when the image formation device 10b receives encrypted print data from the server 40, key information relating to a public key or a secret key never leaks out to the network 2. Thus, the confidentiality of encrypted print data is maintained enough.

In the first preferred embodiment, when the image formation device 10a encrypts the print data 21, the print data 21 is converted to data in a generally applicable format before the encryption. Thus, the image formation device 10b even of a type different from the type of the image formation device 10a is allowed to execute a print job without any problem based on print data obtained by decryption.

In the description given above, after encrypted print data is transmitted from the image formation device 10a to the server 40, a user operates the image formation device 10b to obtain the printout 7. When the user operates the image formation device 10a likewise, the user is also allowed to obtain the printout 7 in situ.

### Second Preferred Embodiment

A second preferred embodiment of the present invention is discussed next. In the first preferred embodiment discussed above, a public key is used to encrypt print data, and the encryption by the public key includes process for prohibiting the print data from being decrypted unless a specific secret key is used. However, the amount of print data is generally large. So, the encryption of print data by a public key takes a long time for computation, decreasing the processing efficiency of the image formation device 10. In the second preferred embodiment, in order to reduce a burden of the encryption of print data, a common key applicable both as an encryption key and a decryption key is used to encrypt print data. In the second preferred embodiment, the overall configuration and the structure of each element of the image formation system 1 are the same as those of the first preferred embodiment. Further, process steps performed by the information processing device 30 for transmitting the print data 21 targeted for secure printing to the image formation device 10a, and the contents of data to be transmitted are the same as those in the first preferred embodiment.

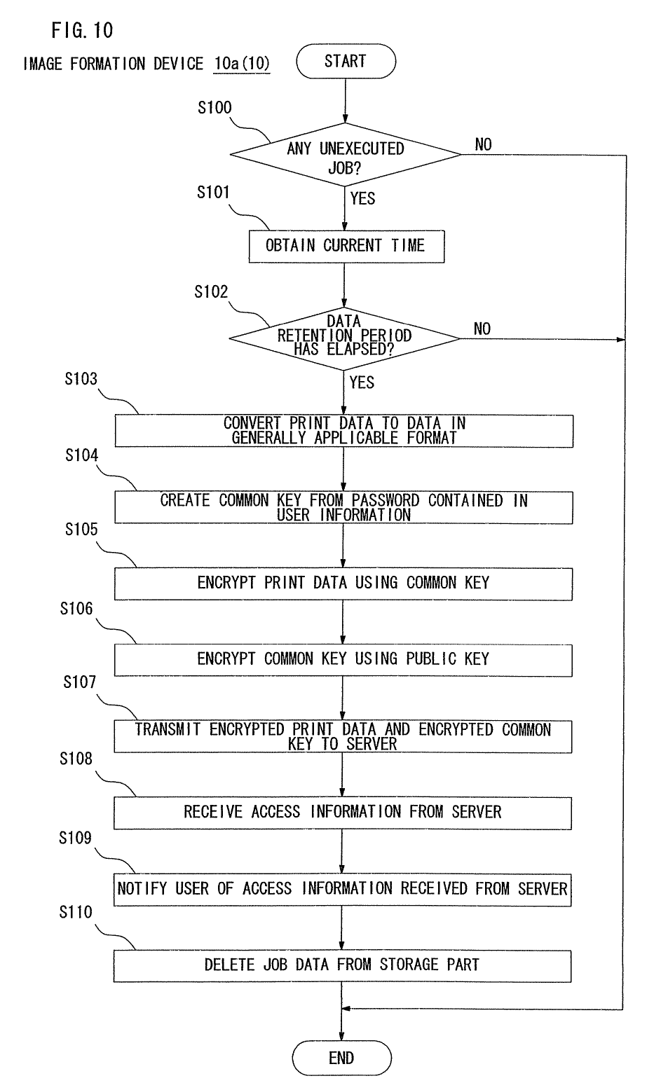

In the second preferred embodiment, the image formation device 10a also stores the print data 21 in the storage part 18 that has been received from the information processing device 30 through the network 2. The job management part 13 manages the print data 21 stored in the storage part 18. When the user 5 does not execute a print job within a predetermined period of time, the image formation device 10a performs processing based on the flow diagram of FIG. 10.

FIG. 10 is a flow diagram showing a process sequence repeatedly performed at a constant frequency by the job management part 13 of the image formation device 10a of the second preferred embodiment. First, the job management part 13 searches the storage part 18 to check whether or not an unexecuted print job is stored therein (step S100). When an unexecuted print job is not stored in the storage part 18 (when a result of step SI 00 is NO), no subsequent process is required so the process sequence stops here. When an unexecuted print job is stored in the storage part 18 (when a result of step S100 is YES), the job management part 13 obtains current time from the clock circuit 17 (step S101). Then, the job management part 13 compares the current time and the date and time of receipt 23 of the print data 21 (see FIG. 2) to check whether or not a period of time set as the data retention period 22c of the additional information 22 has elapsed after the receipt of the print data 21 (step S102). When the data retention period has not elapsed (when a result of step S102 is NO), no subsequent process is required so the process sequence stops here. When the data retention period has already elapsed (when a result of step S102 is YES), subsequent process (steps S103 to S110) follows.

When the data retention period of the print data 21 has already elapsed, the job management part 13 first reads the print data 21 stored in the storage part 18, and converts the print data 21 to data in a generally applicable format (step S103). This step is the same as step S33 in the flow diagram shown in FIG. 7 of the first preferred embodiment.

The job management part 13 thereafter retrieves the password 19b of the user 5 from the user information 19 stored in the storage part 18, and creates a common key from the password 19b (step S104). As an example, the password 19b retrieved from the user information 19 is subjected to computation according to a certain rule to create a common key that is applicable both for encryption and decryption.

Thereafter the job management part 13 encrypts the converted print data in the generally applicable format using the common key (step S105). When the print data is encrypted using the common key, the encrypted print data can be decrypted using the same common key. Namely, the encryption and decryption using the common key correspond to transformation and inverse transformation in terms of data processing. In the first preferred embodiment, the encryption of print data using a public key requires specific process for prohibiting the print data from being successfully decrypted unless a secret key as a counterpart of the public key is used. The encryption of print data using a common key as in the second preferred embodiment does not require such specific process, leading to improved processing efficiency. As discussed above, the amount of print data to be encrypted is large, so the encryption of print data using a public key is a considerably heavy burden. In contrast, print data is encrypted using a common key in the second preferred embodiment. This considerably reduces a burden of the encryption of print data.

When the encryption of the print data using the common key is completed, the job management part 13 encrypts the common key used for the encryption of the print data using the public key 22b contained in the additional information 22 (step S106). This encryption includes process realized by the job management part 13 for prohibiting the common key from being successfully decrypted unless a secret key as a counterpart of the public key 22b is used. The common key is extremely smaller in data amount than the print data. Thus, the encryption of the common key using the public key 22b requires a shorter period of time, thereby realizing efficient processing.

When the encryption of the common key is completed, the job management part 13 transmits the print data encrypted by the common key, and the common key encrypted by the public key 22b to the server 40 (step S107). The attribute information 22a contained in the additional information 22 may be added to the encrypted print data and the encrypted common key transmitted to the server 40. However, the other pieces of information (public key 22b and data retention period 22c) are not added to the encrypted print data and the encrypted common key transmitted to the server 40. The job management part 13 thereby encrypts the print data 21 containing confidential information using the common key, and transmits the encrypted print data to the server 40. The job management part 13 also encrypts the common key used for the encryption of the print data 21 using the public key 22b, and transmits the encrypted common key to the server 40. The public key 22b used for the encryption of the common key does not leak out to the network 2. Thus, the print data and the common key are transmitted to the server 40 with the security of the print data 21 and the common key maintained.

When the server 40 receives the encrypted print data and the encrypted common key from the image formation device 10a, the server 40 stores them in a certain folder. At this time, the server 40 performs the same process as in the first preferred embodiment (as discussed with reference to the flow diagram of FIG. 8). The server 40 thereby generates access information for making access to the folder storing therein the encrypted print data and the encrypted common key, and transmits the access information to the image formation device 10a.

The image formation device 10a receives the access information from the server 40 (step S108). When the access information is received from the server 40, the job management part 13 notifies the user 5 of the received access information (step S109). This step is the same as step S37 in the flow diagram shown in FIG. 7 of the first preferred embodiment. After the notification of the access information to the user 5, the job management part 13 deletes the print job data 20 from the storage part 18 (step S110). This prevents the print job data 20 for which a print job has not been executed from continuously occupying an available area of the storage part 18 of the image formation device 10a. This also prevents confidential information from being continuously held in the storage part 18 of the image formation device 10a.

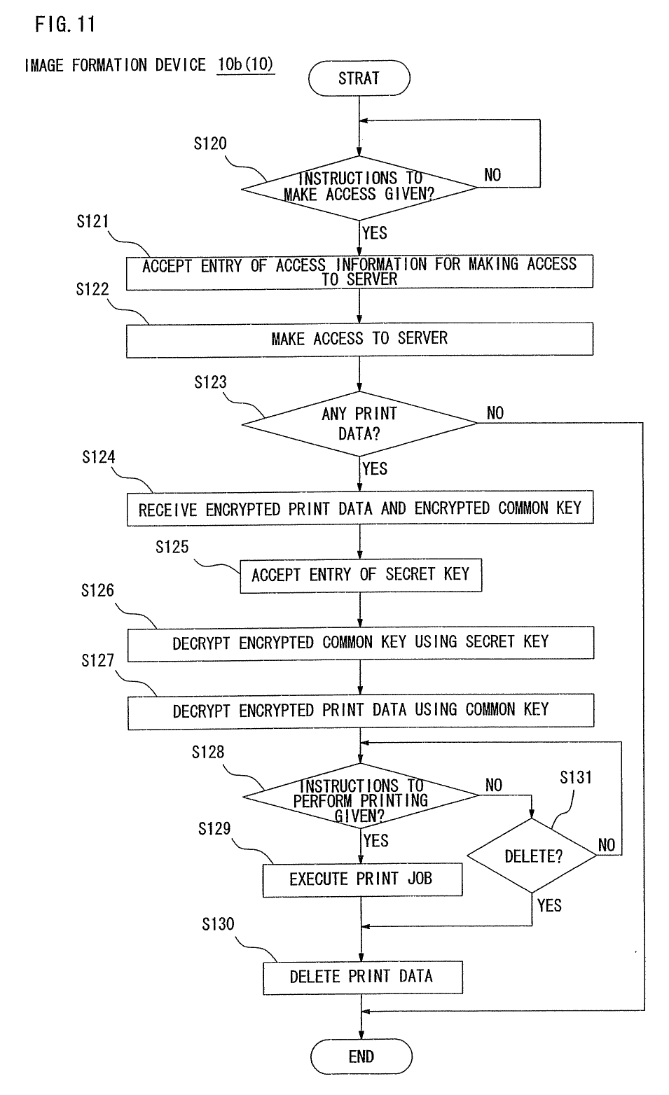

Discussed next is a procedure in the second preferred embodiment in which, when the user 5 is notified of the access information from the image formation device 10a at a place to which the user 5 has moved, the user 5 operates the nearest image formation device 10b to cause the image formation device 10b to execute a print job targeted for secure printing, thereby obtaining the printout 7 in situ. FIG. 11 is a flow diagram showing a process sequence performed by the image formation device 10b in the second preferred embodiment. The user 5 operates the operation panel 15 of the image formation device 10b to give instructions to make access to the server 40 to obtain print data through the network 2 (step S120). When the user 5 gives instructions to make access to the server 40 (when a result of step S120 is YES), the job management part 13 of the image formation device 10b is brought into operation to display an entry screen for access information on the display part 15a of the operation panel 15, while accepting the entry of access information for making access to the server 40 made through the operation part 15b (step S121). At this time, the user 5 enters access information for making access to the server 40 based on the access information notified from the image formation device 10a. Then, the job management part 13 makes access to the server 40 based on the access information thereby entered (step S122). When the job management part 13 logs in to the server 40 using a one-time password entered by the user 5, for example, the server 40 is allowed to specify a folder storing therein encrypted print data corresponding to this one-time password, by which the folder becomes accessible by the job management part 13.

Thereafter the job management part 13 determines whether or not encrypted print data is stored in the folder to which access has been made (step S123). When encrypted print data is not stored in the folder (when a result of step S123 is NO), no subsequent process is practicable so the process sequence stops here. When encrypted print data is stored in the folder (when a result of step S123 is YES), the job management part 13 retrieves the encrypted print data and an encrypted common key from the server 40 (step S124).

The job management part 13 displays an entry screen for a secret key for decrypting the encrypted common key on the display part 15a of the operation panel 15 to accept the entry of the secret key through the operation part 15b (step S125). Then, the user 5 enters a secret key as a counterpart of the public key 22b to the image formation device 10b. The job management part 13 decrypts the encrypted common key retrieved from the server 40 using the secret key entered by the user 5 (step S126). After the decryption of the common key, the encrypted print data is decrypted next using the decrypted common key (step S127). As a result, the print data targeted for secure printing is converted to print data in a generally applicable print format such as raster data or PDF data.

When instructions for printing given from the user 5 are received through the operation panel 15 (when a result of step S128 is YES), the job management part 13 brings the job execution part 14 into operation so that the job execution part 14 executes a print job (step S129). The job execution part 14 actuates the printer mechanism 29 to form an image on a sheet based on the decrypted print data to obtain the printout 7.

When the print job is completed, the job management part 13 deletes the print data and the common key stored in the image formation device 10b, and deletes the encrypted print data and the encrypted common key stored in the server 40 (step S130). As a result, confidential information is deleted from the image formation device 10b and the server 40. In the second preferred embodiment, when instructions for printing are not given in step S128 (when a result of step S128 is NO), an inquiry as to the deletion is also made to the user 5. When instructions for deletion are given (when a result of step S131 is YES), the job management part 13 deletes the print data and the common key stored in the image formation device 10b, and deletes the encrypted print data and the encrypted common key stored in the server 40 (step S130). Thus, confidential information is deleted from the image formation device 10b and the server 40 without executing a print job.

In the second preferred embodiment, the image formation device 10 encrypts print data using a common key that is also used to decrypt the print data. So the encryption of print data does not require specific process, and encryption is efficiently realized even when print data is in large amounts. Thus, the image formation system 1 of the second preferred embodiment improves the processing efficiency of the image formation system 1 as a whole to a greater degree while achieving the same effect as in the first preferred embodiment.

In the second preferred embodiment, a common key is created from the password 19b of the user 5 stored in the image formation device 10a. The common key thereby created is eventually transmitted to the image formation device 10b. Thus, even when the user 5 is not registered with the image formation device 10b, for example, the password 19b is reconstructed from the common key in the image formation device lob. So, user authentication is allowed using the reconstructed password 19b as a temporary password. More specifically, if the user 5 is authenticated at the image formation device 10b by giving instructions for printing through the operation panel 15 in step S128 discussed above, an entry screen for a password is displayed on the operation panel 15, and the execution of a print job is allowed when an entry made thereto coincides with the reconstructed password 19b. Thus, in the second preferred embodiment, the image formation device 10 with which the user 5 is not registered is temporarily used to obtain the printout 7. This further improves the convenience of the image formation system 1.

### Third Preferred Embodiment

A third preferred embodiment of the present invention is discussed next. In the above-discussed first and second preferred embodiments, the image formation device 10a transmits print data to the server 40. When the user 5 is notified of access information on the print data generated in the server 40 from the image formation device 10a, the user 5 is required to move to the nearest image formation device 10 to delete the print data from the server 40 even when the user 5 no longer requires the execution of a print job. In the third preferred embodiment, the user 5 operates the information processing device 30 of its own to process print data transmitted to the server 40. In the third preferred embodiment, process steps performed by the information processing device 30 for transmitting the print data 21 targeted for secure printing to the image formation device 10a, and the contents of data to be transmitted are the same as those in the first preferred embodiment.

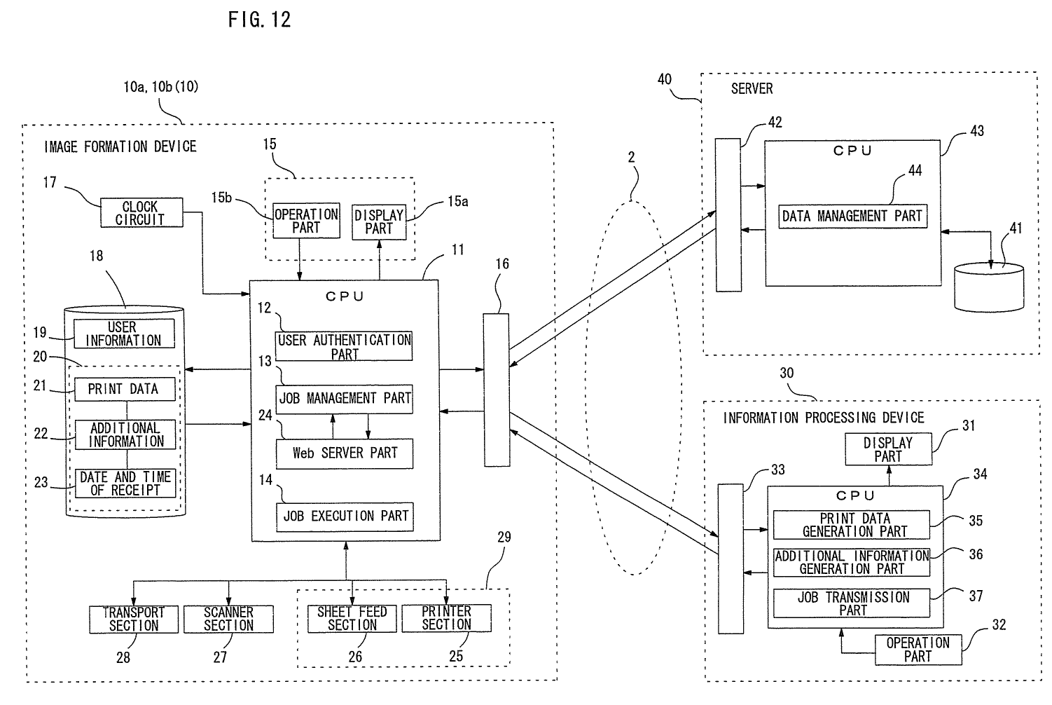

FIG. 12 is a block diagram showing the functional configuration of the image formation system 1 of the third preferred embodiment. The image formation system 1 of the third preferred embodiment is different from that of the first preferred embodiment in that, the CPU 11 of the image formation device 10 is operative to function as a Web server part 24 as well as the user authentication part 12, the job management part 13 and the job execution part 14. The Web server part 24 transmits a job handling screen in the form of what is called a Web page for handling a job to the information processing device 30 connected to the network 2, and receives instructions on job handling from the information processing device 30. The provision of the Web server part 24 in the image formation device 10 eliminates the necessity to install a dedicated program in the information processing device 30 for realizing direct data communication with the image formation device 10. The information processing device 30 is only required to start a generally employed browser program (browser software) for browsing what are called Internet sites and the like to realize data communication with the Web server part 24. The Web server part 24 is not necessarily provided as one of the functions of the CPU 11 as in FIG. 12, but may be realized in a CPU different from the CPU 11, or may be configured as an external device added externally to the image formation device 10.

In the third preferred embodiment, the Web server part 24 is brought into operation after the image formation device 10 transmits print data to the server 40. The Web server part 24 causes the information processing device 30 to display a job handling screen, and receives job handling instructions from the information processing device 30. Job handling instructions the Web server part 24 has received from the information processing device 30 are transmitted to the job management part 13. Then, the job management part 13 deletes the print data stored in the server 40 or perform setting change of the print data based on the job handling instructions. Here, the setting change relates to the change of setting of print data, and includes various changes. As an example, single-sided printing may be changed to double-sided printing.

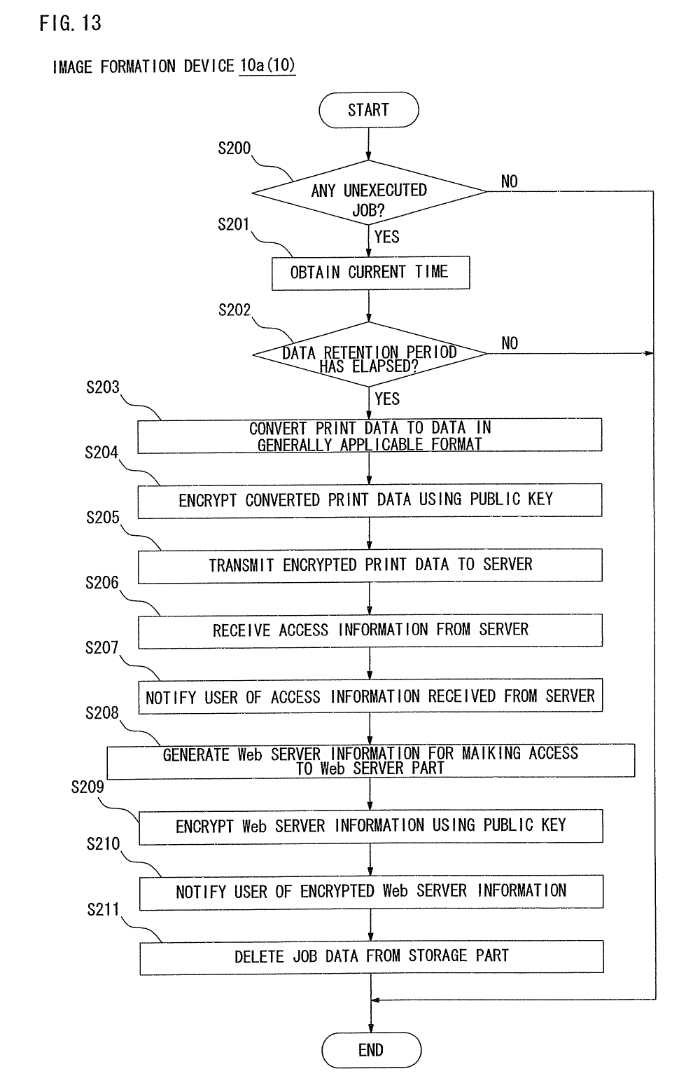

In the third preferred embodiment, the image formation device 10a also stores the print data 21 in the storage part 18 that has been received from the information processing device 30 through the network 2. The job management part 13 manages the print data 21 stored in the storage part 18. When the user 5 does not execute a print job within a predetermined period of time, the image formation device 10a performs processing based on the flow diagram of FIG. 13.

FIG. 13 is a flow diagram showing a process sequence repeatedly performed at a constant frequency by the job management part 13 of the image formation device 10a of the third preferred embodiment. The job management part 13 searches the storage part 18 to check whether or not an unexecuted print job is stored therein (step S200). When an unexecuted print job is not stored in the storage part 18 (when a result of step S200 is NO), no subsequent process is required so the process sequence stops here. When an unexecuted print job is stored in the storage part 18 (when a result of step S200 is YES), the job management part 13 obtains current time from the clock circuit 17 (step S201). Then, the job management part 13 compares the current time and the date and time of receipt 23 of the print data 21 to check whether or not a period of time set as the data retention period 22c of the additional information 22 has elapsed after the receipt of the print data 21 (step S202). When the data retention period has not elapsed (when a result of step S202 is NO), no subsequent process is required so the process sequence stops here. When the data retention period has already elapsed (when a result of step S202 is YES), subsequent process (steps S203 to S211) follows.

When the data retention period of the print data 21 has already elapsed, the job management part 13 first reads the print data 21 stored in the storage part 18, and converts the print data 21 to data in a generally applicable format (step S203). This step is the same as step S33 in the flow diagram shown in FIG. 7 of the first preferred embodiment.

The job management part 13 thereafter encrypts the converted print data in the generally applicable format using the public key 22b (step S204). Here, like in the first preferred embodiment, the public key 22b is used to encrypt the print data. Alternatively, as discussed in the second preferred embodiment, a common key may be created from a password, and the common key may be used to encrypt the print data. In the third preferred embodiment, in the encryption of the print data, the print data and setting information relating to printing are separated. The print data is encrypted while the setting information is left unencrypted. After the encryption, the job management part 13 transmits the encrypted print data to the server 40 (step S205). At this time, the setting information left unencrypted is transmitted to the server 40 together with the encrypted print data.

Like in the first and second preferred embodiments, the image formation device 10a thereafter obtains access information from the server 40 (step S206). After the access information is received from the server 40, the job management part 13 notifies the received access information to the user 5 (step S207).

Then, the job management part 13 generates Web server information for making access to the Web server part 24 (step S208). This Web server information contains for example a URL for making access to the Web server part 24, an ID and a password for displaying a job handling screen, and the like. The job management part 13 encrypts the Web server information using the public key 22b (step S209), and notifies the user 5 of the encrypted Web server information (step S210). As an example, like in step S207, the notification of the encrypted Web server information is realized by transmitting an electronic mail containing the Web server information to the electronic mail address 19c of the user 5 contained in the user information 19. After the Web server information is notified to the user 5, the job management part 13 deletes the print job data 20 from the storage part 18 (step S21 1).

When the user 5 who has been notified of the access information from the image formation device 10a by the process discussed above wishes to execute a print job targeted for secure printing, the user 5 moves to the nearest image formation device 10 and operates the same to obtain the printout 7 as discussed in the first and second preferred embodiments.

When the user 5 who has been notified of the Web server information from the image formation device 10a wishes to delete print data or change the setting of the print data, the user 5 first operates the information processing device 30 to decrypt the encrypted Web server information received from the image formation device 10a. Namely, the user 5 enters a secret key to the information processing device 30 to decrypt the encrypted Web server information at the information processing device 30, by which the user 5 is allowed to know a URL for making access to the Web server part 24, an ID and a password for displaying a job handling screen, and the like. The user 5 continues to operate the information processing device 30 to start a generally employed browser program and enters information based on the Web server information, thereby making access from the information processing device 30 to the Web server part 24.

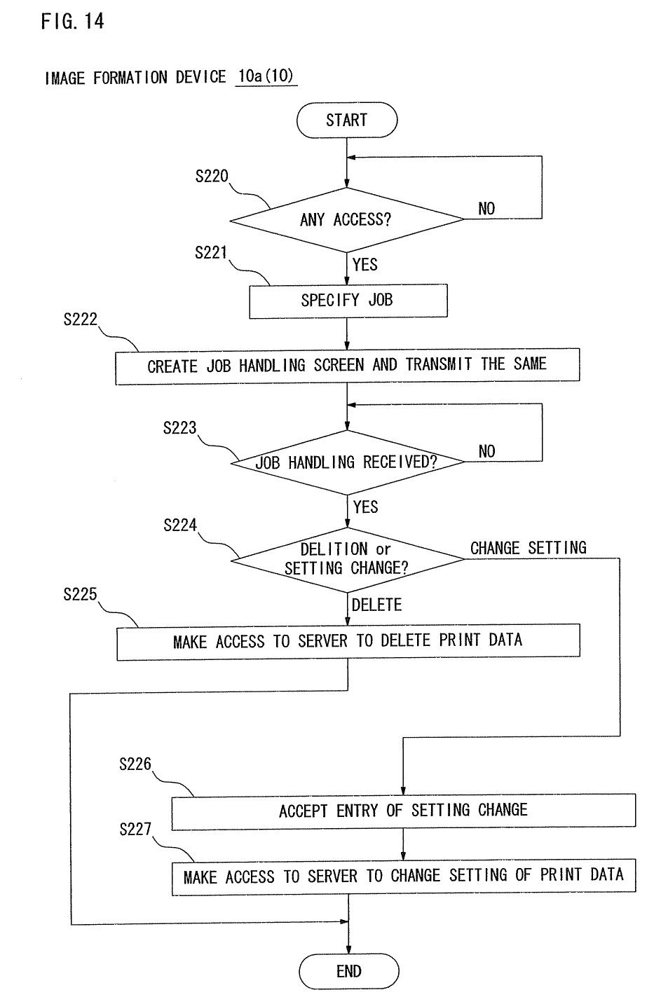

FIG. 14 is a flow diagram showing a process sequence performed by the image formation device 10a when the information processing device 30 makes access to the Web server part 24. The Web server part 24 keeps watch on the presence of access from the information processing device 30 (step S220). When access is made, the Web server part 24 specifies a job based on an ID, a password and the like entered from the information processing device 30 (step S221). Then, the Web server part 24 creates a job handling screen for the corresponding job, and transmits the same to the information processing device 30 (step S222). This job handling screen includes for example a selection bottom for making selection between the deletion, setting change and the like of a print job. Here, the setting change of a print job relates to the change of setting for printing that include printing setting such as the number of sheets to be printed, the size of printing sheets, selection between color printing and black-and-white printing, selection between single-sided printing and double-sided printing, as well as setting for post-processing such as stapling.

Thereafter the Web server part 24 is placed in a standby mode until job handling is received from the information processing device 30 (step S223). When job handling is received, the Web server part 24 determines whether the job handling relates to the deletion or setting change (step S224). When the job handling relates to the deletion of a print job, the Web server part 24 gives instructions to the job management part 13 to delete the print job. This causes the job management part 13 to make access to the server 40 to delete encrypted print data stored in the storage device 41 (step S225). When the job handling relates to setting change, the Web server part 24 creates another screen for setting change, transmits the same to the information processing device 30 to accept the entry of setting change from the information processing device 30 (step S226). When instructions for setting change are received from the information processing device 30, the Web server part 24 gives instructions to the job management part 13 to change the setting of a print job. Then, the job management part 13 makes access to the server 40, reads unencrypted setting information stored in the storage device 41 together with encrypted print data, and changes the contents of the setting information according to the instructions (step S227).

As a result, without the need to move to the nearest image formation device 10, the user 5 is allowed to delete print data or change the setting of the print data transmitted to the server 40 by operating the information processing device 30 of its own, thereby improving operation performance. Especially when the user 5 no longer requires the execution of a print job, the user 5 is only required to operate the information processing device 30 of its own without moving to the nearest image formation device 10, to thereby immediately delete print data containing confidential information from the server 40.

### Fourth Preferred Embodiment

A fourth preferred embodiment of the present invention is discussed next. In the above-discussed third preferred embodiment, after the image formation device 10a transmits print data to the server 40, the user 5 operates the information processing device 30 to delete the print data or change the setting of the print data stored in the server 40. In the fourth preferred embodiment, before the image formation device 10a transmits print data to the server 40, the user 5 operates the information processing device 30 to transmit or delete the print data, or change the setting of the print data. In the fourth preferred embodiment, the overall configuration and the structure of each element of the image formation system 1 are the same as those of the first preferred embodiment (see FIG. 12). Further, process steps performed by the information processing device 30 for transmitting the print data 21 targeted for secure printing to the image formation device 10a, and the contents of data to be transmitted are the same as those in the first preferred embodiment.

In the fourth preferred embodiment, the Web server part 24 is brought into operation before the image formation device 10 transmits print data to the server 40. The Web server part 24 causes the information processing device 30 to display a job handling screen, and receives job handling instructions from the information processing device 30. Job handling instructions the Web server part 24 has received from the information processing device 30 are transmitted to the job management part 13. Then, the job management part 13 transmits or deletes the print data 21 stored in the storage part 18, or change the setting of the print data 21 based on the job handling instructions.

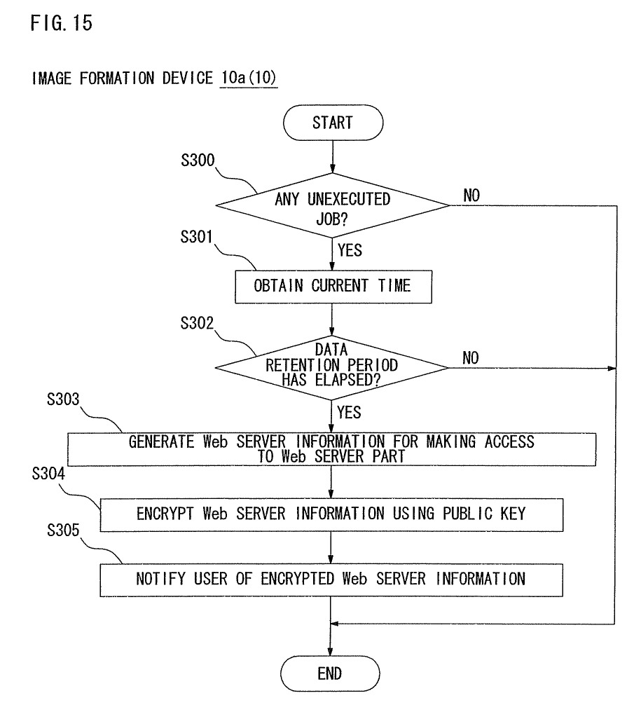

In the fourth preferred embodiment, the image formation device 10a also stores the print data 21 in the storage part 18 that has been received from the information processing device 30 through the network 2. The job management part 13 manages the print data 21 stored in the storage part 18. When the user 5 does not execute a print job within a predetermined period of time, the image formation device 10a performs processing based on the flow diagram of FIG. 15.

FIG. 15 is a flow diagram showing a process sequence repeatedly performed at a constant frequency by the job management part 13 of the image formation device 10a of the fourth preferred embodiment. The job management part 13 searches the storage part 18 to check whether or not an unexecuted print job is stored therein (step S300). When an unexecuted print job is not stored in the storage part 18 (when a result of step S300 is NO), no subsequent process is required so the process sequence stops here. When an unexecuted print job is stored in the storage part 18 (when a result of step S300 is YES), the job management part 13 obtains current time from the clock circuit 17 (step S301). Then, the job management part 13 compares the current time and the date and time of receipt 23 of the print data 21 to check whether or not a period of time set as the data retention period 22c of the additional information 22 has elapsed after the receipt of the print data 21 (step S302). When the data retention period has not elapsed (when a result of step S302 is NO), no subsequent process is required so the process sequence stops here. When the data retention period has already elapsed (when a result of step S302 is YES), subsequent process (steps S303 to S305) follows.

When the data retention period of the print data 21 has already elapsed, the job management part 13 generates Web server information for making access to the Web server part 24 (step S303). This Web server information contains for example a URL for making access to the Web server part 24, an ID and a password for displaying a job handling screen, and the like. The job management part 13 encrypts the Web server information using the public key 22b (step S304), and notifies the user 5 of the encrypted Web server information (step S305). As an example, like in step S210 of the third preferred embodiment (FIG. 13), the notification of the encrypted Web server information is realized by transmitting an electronic mail containing the Web server information to the electronic mail address 19c of the user 5 contained in the user information 19.

When the user 5 who has been notified of the Web server information from the image formation device 10a by the process discussed above wishes to transmit or delete print data, or change the setting of the print data, the user 5 first operates the information processing device 30 to decrypt the encrypted Web server information received from the image formation device 10a. Namely, the user 5 enters a secret key to the information processing device 30 to decrypt the encrypted Web server information at the information processing device 30, by which the user 5 is allowed to know a URL for making access to the Web server part 24, an ID and a password for displaying a job handling screen, and the like. The user 5 continues to operate the information processing device 30 to start a generally employed browser program and enters information based on the Web server information, thereby making access from the information processing device 30 to the Web server part 24.

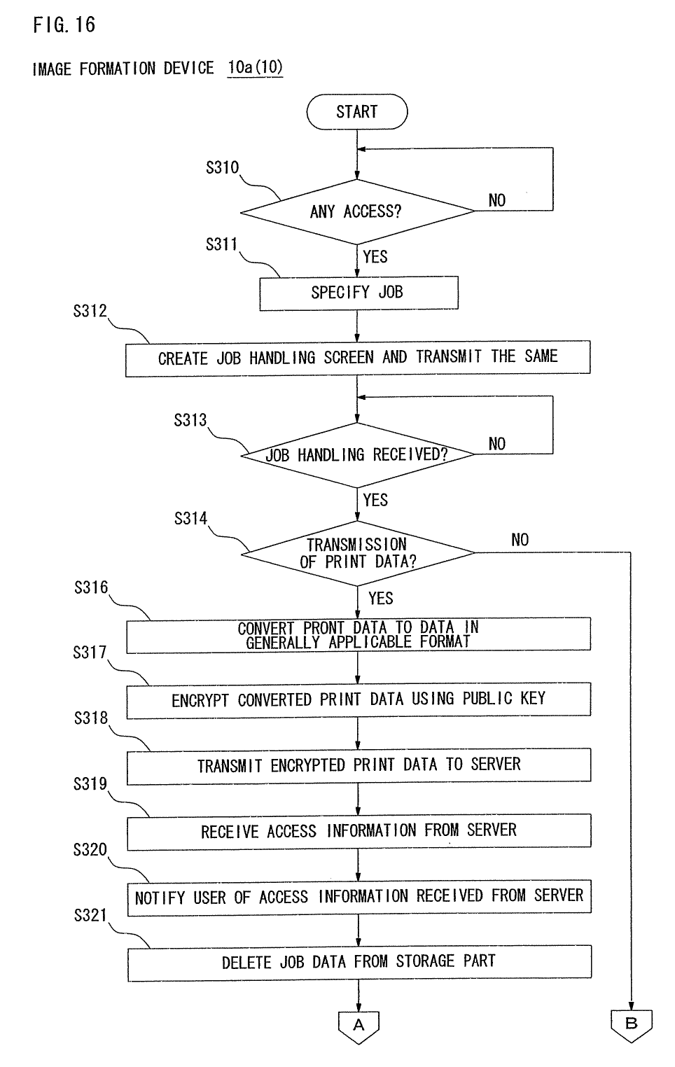

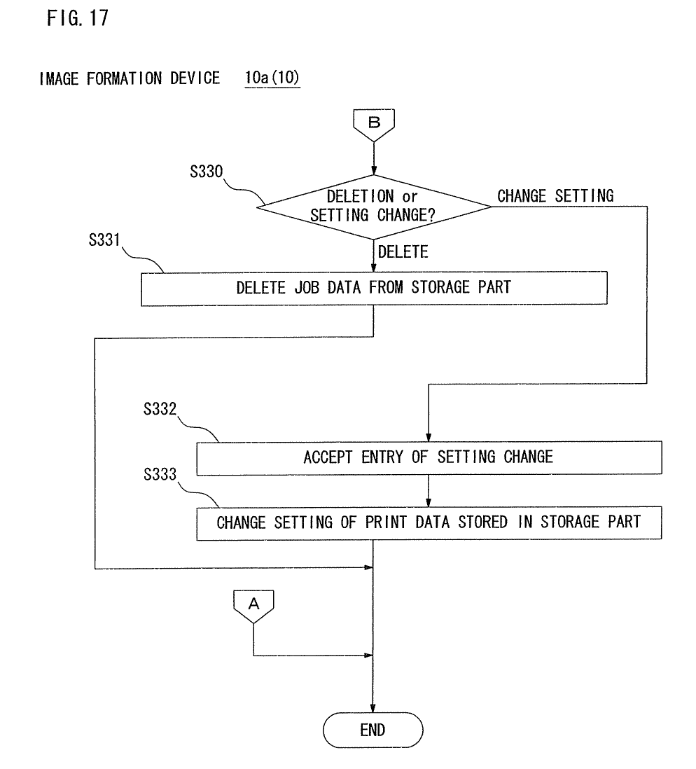

FIGS. 16 and 17 are flow diagrams showing a process sequence performed by the image formation device 10a when the information processing device 30 makes access to the Web server part 24. The Web server part 24 keeps watch on the presence of access from the information processing device 30 (step S310). When access is made, the Web server part 24 specifies a job based on an ID, a password and the like entered from the information processing device 30 (step S311). Then, the Web server part 24 creates a job handling screen for the corresponding job, and transmits the same to the information processing device 30 (step S312). This job handling screen includes for example a selection bottom for making selection between the transmission, deletion, setting change and the like of print data.

Thereafter the Web server part 24 is placed in a standby mode until job handling is received from the information processing device 30 (step S313). When job handling is received, the Web server part 24 determines whether the job handling relates to the transmission of print data (step S314).

When the job handling relates to the transmission of print data (when a result of step S314 is YES), the Web server part 24 gives instructions to the job management part 13 to transmit print data. In response, the job management part 13 reads the print data 21 stored in the storage part 18, and converts the print data 21 to data in a generally applicable format (step S316). This step is the same as step S33 in the flow diagram shown in FIG. 7 of the first preferred embodiment.

The job management part 13 thereafter encrypts the converted print data in the generally applicable format using the public key 22b (step S317). Here, like in the first preferred embodiment, the public key 22b is used to encrypt the print data. Alternatively, as discussed in the second preferred embodiment, a common key may be created from a password, and the common key may be used to encrypt the print data. After the encryption, the job management part 13 transmits the encrypted print data to the server 40 (step S318).

Like in the first and second preferred embodiments, the image formation device 10a thereafter obtains access information from the server 40 (step S319). After the access information is received from the server 40, the job management part 13 notifies the received access information to the user 5 (step S320), and thereafter deletes the print job data 20 from the storage part 18 (step S321). This prevents the print job data 20 for which a print job has not been executed from continuously occupying an available area of the storage part 18 of the image formation device 10a. This also prevents confidential information from being continuously held in the storage part 18 of the image formation device 10a.

When the job handling does not relates to the transmission of print data (when a result of step S314 is NO), the Web server part 24 determines whether the job handling relates to the deletion or setting change of print data (step S330 of FIG. 17).

When the job handling relates to the deletion of a print job, the Web server part 24 gives instructions to the job management part 13 to delete the print job. This causes the job management part 13 to delete the print job data 20 containing the print data 21 from the storage part 18 (step S331). When the job handling relates to setting change, the Web server part 24 further creates a screen for setting change, transmits the same to the information processing device 30 to accept the entry of setting change from the information processing device 30 (step S332). When instructions for setting change are received from the information processing device 30, the Web server part 24 gives instructions to the job management part 13 to change the setting of a print job. Then, the job management part 13 reads the setting information of the print data 21 stored in the storage part 18, and changes the contents of the setting information according to the instructions (step S333). In order to transmit this print data 21 to the server 40, job handling may be performed again.

As a result, without the need to move to the nearest image formation device 10, the user 5 is allowed to transmit or delete print data that has been stored in the image formation device 10a for a period longer than a predetermined period after having being transmitted to the image formation device 10a, or change the setting of the print data by operating the information processing device 30 of its own. Especially in the fourth preferred embodiment, the user 5 is allowed to give instructions to transmit print data to the server 40. Namely, when the user 5 wishes to obtain the printout 7 at the nearest image formation device 10b, for example, the user 5 operates the information processing device 30 to transmit print data to the server 40. The user 5 thereafter operates the image formation device 10b based on access information notified from the image formation device 10a, so that the user 5 is allowed to obtain the printout 7 in situ. When the user 5 does not require a printout, the user 5 operates the information processing device 30 of its own to immediately delete print data containing confidential information from the storage part 18 before the print data is transmitted from the image formation device 10a to the server 40.

While the invention has been shown and described in detail, the foregoing description is in all aspects illustrative and not restrictive. It is therefore understood that numerous modifications and variations can be devised without departing from the scope of the invention.

What is claimed is:

1. An image formation device connected to a network, comprising:
a storage part for storing therein print data targeted for secure printing received through said network;
an authentication part responsible for user authentication;
a job execution part for reading said print data targeted for secure printing from said storage part to execute a print job when a user is authenticated by said authentication part; and
a job management part for managing said print data targeted for secure printing stored in said storage part, wherein
when a print job is not executed at a point in time after the elapse of a predetermined period of time after the receipt of said print data targeted for secure printing, said job management part encrypting said print data using a certain encryption key, and transmitting the encrypted print data to an intended storage device connected to said network.

2. The image formation device according to claim 1, wherein
the transmission of said encrypted print data causes said job management part to delete said print data targeted for secure printing from said storage part that has been received through said network.

3. The image formation device according to claim 1, wherein
said job management part notifies information on a destination of said encrypted print data through said network to a source of said print data targeted for secure printing.

4. The image formation device according to claim 3, wherein
in order to notify said information on said destination of said encrypted print data, said job management part sends an electronic mail to an address registered in advance as a source of said print data targeted for secure printing.

5. The image formation device according to claim 1, wherein
said print data targeted for secure printing received through said network is accompanied by a public key for encryption, and
said job management part uses said public key received together with said print data targeted for secure printing as said certain encryption key.

6. The image formation device according to claim 5, further comprising a manipulated input part for receiving manipulation from a user, wherein
when instructions to obtain a printout of print data transmitted to said intended storage device are received through said manipulated input part, said job management part retrieves said encrypted print data from said intended storage device, decrypts said encrypted print data using a secret key entered through said manipulated input part, and causes said job execution part to execute a print job.

7. The image formation device according to claim 1, wherein
said print data targeted for secure printing received through said network is accompanied by a public key for encryption,
said storage part further stores therein user information referred to by said authentication part, and
said job management part creates a common key from said user information, encrypts said print data targeted for secure printing using said common key as said certain encryption key, encrypts said common key using said public key, and transmits said print data encrypted by said common key and said common key encrypted by said public key to said intended storage device.

8. The image formation device according to claim 7, further comprising a manipulated input part for receiving manipulation from a user, wherein
when instructions to obtain a printout of print data transmitted to said intended storage device are received through said manipulated input part, said job management part retrieves the encrypted common key and the encrypted print data from said intended storage device, decrypts said encrypted common key using a secret key entered through said manipulated input part, decrypts said encrypted print data using the decrypted common key, and causes said job execution part to execute a print job.

9. The image formation device according to claim 1, further comprising a Web server part for causing an information processing device connected to said network to display a job handling screen to receive job handling instructions from said information processing device, wherein
said job management part transmits or deletes said print data targeted for secure printing, or changes the setting of said print data based on said job handling instructions said Web server part has received from said information processing device.

10. An image formation system comprising:
a first second image formation device connected to a network;
a second image formation device connected to said network;
a server connected to said network, and including a storage device for storing therein print data transmitted from said first or second image formation device; and
an information processing device connected to said network, and transmitting print data targeted for secure printing to said first or second image formation device, said first and second image formation devices each including:
a manipulated input part for receiving manipulation from a user, a storage part for storing therein said print data targeted for secure printing received from said information processing device;
an authentication part responsible for user authentication;
a job execution part for reading said print data targeted for secure printing from said storage part to execute a print job when a user is authenticated by said authentication part; and
a job management part for managing said print data targeted for secure printing stored in said storage part,
when a print job is not executed at a point in time after the elapse of a predetermined period of time after the receipt of said print data targeted for secure printing, said job management part encrypting said print data using a certain encryption key, and transmitting the encrypted print data to said server to store said encrypted print data into said storage device, while transmitting information for making access to a destination to save said encrypted print data through said network to a source of said print data targeted for secure printing,
in said first or second image formation device, when instructions to obtain a printout of print data transmitted to said server are received through said manipulated input part, said job management part of the image formation device making access to said storage device of said server based on said information entered through said manipulated input part to retrieve said encrypted print data, decrypting said encrypted print data using a certain decryption key, and causing said job execution part of said image formation device to execute a print job.

11. The image formation system according to claim 10, wherein
said information processing device transmits said print data targeted for secure printing together with a public key for encryption, and
said job management part encrypts said print data targeted for secure printing using said public key received together with said print data, and decrypts the encrypted print data using a secret key entered through said manipulated input part.

12. The image formation system according to claim 10, wherein
in each of said first and second image formation devices, user information referred to by said authentication part is stored in said storage part,
said information processing device transmits said print data targeted for secure printing together with a public key for encryption,
when said print data targeted for secure printing is transmitted to said server, said job management part creates a common key from said user information, encrypts said print data using said common key as said certain encryption key, encrypts said common key using said public key, and transmits said print data encrypted by said common key and said common key encrypted by said public key to said server, and
when instructions to obtain a printout of print data transmitted to said server are received through said manipulated input part, said job management part retrieves the encrypted common key and the encrypted print data from said server, decrypts said encrypted common key using a secret key entered through said manipulated input part, decrypts said encrypted print data using the decrypted common key, and causes said job execution part to execute a print job.
